(19) United States
(12) Patent Application Publication
(10) Pub. No.: US 2004/0244245 A1
(43) Pub. Date: Dec. 9, 2004

(54) Low cost versatile message board with advertising space

(76) Inventor: Mohamed Abdelrahman, Cookeville, TN (US)

Correspondence Address: The Law Offices of Jessica Costa, PC, 501 Collings Avenue, Collingswood, NJ, 08107-1607, US

(21) Appl. No.: 10/727,254

(22) Filed: Dec. 3, 2003

Related U.S. Application Data
(60) Provisional application No. 60/476,053, filed on Jun. 4, 2003.

(51) Int. Cl. G09F 11/04

(52) U.S. Cl. 40/495

(57) ABSTRACT

A message board having multiple surfaces connected together such that they are rotatable with respect to one or more axes. In its simplest design, the message board includes two surfaces rotatable around a single axis. The first surface includes a set of messages arranged on its front face in a predefined pattern. The second surface is stacked over the front face of the first surface, covering the set of messages on the front face of the first surface. The second surface includes one or more windows that allow selection and display of a subset of the messages available on the first surface as the two surfaces are rotated with respect to each other. In other embodiments, the message board includes additional stacked surfaces that may include messages and/or windows, wherein proper alignment and relative rotation of the plurality of surfaces reveal selected messages distributed over the surfaces. The message board of the invention provides a fast efficient method of selecting and displaying a subset of available messages distributed over the message board surfaces. Persistently exposed areas of the surfaces or persistently exposed additional surfaces may also be provided to allow persistent display of advertisements, customized names and/or logos, or other text and/or images. The message board may include means by which it can be attached to surfaces to assist in the persistent display of the messages and advertisement.

### BACKGROUND OF THE INVENTION

The invention relates to message boards and particularly those message boards that allow the display of interchangeable messages.

Message boards are used to convey messages to those viewing it. A message board is typically placed in an area of high traffic or where the intended audience is likely to notice it. Once placed, a message board is generally infrequently moved, if at all. Accordingly, message boards are characterized as being persistently displayed.

Prior art message boards generally fall into one of three categories. The first category generally comprises an erasable board, which offers a space where messages can be hand written and erased using some type of marker or chalk. U.S. Pat. No. 5,352,535 presents an example of this type of message board. The obvious disadvantage of such boards is the effort required in the handwriting and erasing the previous messages on the board. The legibility of the messages is variable and depends on the quality of the handwriting. The use of this type of board requires the maintenance of writing instruments and cleaning tools.

The second category of message board generally comprises those boards that provide changeable, alphanumeric character bearing elements. The characters are arranged over a given space to form the desired message. An example of such a message board is described in U.S. Pat. No. 4,738,043. These boards offer flexibility to form various messages with reasonable quality. However, the process of forming the message from characters is time consuming. The messages to be written are limited by the availability of certain characters.

The third category of message boards generally includes those that provide a selection of cards bearing display information and a set of defined slots in which these cards can be inserted. Examples of such boards are described in U.S. Pat. Nos. 4,171,584 and 4,129,857. Although these boards offer an advantage over the previous kinds in terms of the time and effort required to change the message, they do require management and storage of the set of message cards. In order to change a message, the old message card has to be removed and a new card inserted in the new slot. This process becomes tedious when messages have to be frequently changed. Accordingly, it would be desirable to have a message board that overcomes the disadvantages of prior art message boards described above.

### SUMMARY OF THE INVENTION

The present invention is a low cost message board and method of making the same. The message board is configurable to display a subset of a larger set of pre-determined messages. The messages to be displayed are selectable with minimal effort and time.

The message board of the invention comprises a plurality of surfaces connected together such that they are rotatable with respect to a single axis or multiple axes. In its simplest design, the message board includes two surfaces rotatable around a single axis. The first surface includes a set of messages arranged on its front face in a predefined pattern. The second surface is stacked over the front face of the first surface, covering the set of messages on the front face of the first surface. The second surface includes one or more windows that allow selection and display of a subset of the messages available on the first surface as the two surfaces are rotated with respect to each other. In other embodiments, the message board includes additional stacked surfaces that may include messages and/or windows, wherein proper alignment and relative rotation of the plurality of surfaces reveals selected messages distributed over the surfaces. The message board of the invention provides a fast efficient method of selecting and displaying a subset of available messages distributed over the message board surfaces. Persistently exposed areas of the surfaces or persistently exposed additional surfaces may also be provided to allow persistent display of advertisements, customized names and/or logos, or other text and/or images.

The message board of the invention is especially suitable when messages need to be frequently changed. It is suitable for display on office, residence, or refrigerator doors. It can be used to display messages regarding the availability status of a person in his office or residence. It can also be used as a reminder of important to-do tasks. The message board may also be adapted to be used in retail stores or other commercial facilities.

### BRIEF DESCRIPTION OF THE DRAWINGS

FIG. 1 is front view of an assembled message board implemented in accordance with one preferred embodiment of the present invention;

FIG. 2 is a perspective exploded view of the message board of FIG. 1;

FIG. 3 is front view of an assembled message board implemented in accordance with a second preferred embodiment of the present invention;

FIG. 4 is a perspective exploded view of the message board of FIG. 3;

FIG. 5 is a cross-sectional side view of the message board of FIG. 3;

FIG. 6 is a plan view of a surface of the message board showing a sample windows arrangement;

FIG. 7 is a view of one surface of the message board showing sample messages;

FIG. 8 is a plan view of a surface of the message board showing an arrangement allowing radial repositioning of windows; and

FIG. 9 is front view of an assembled message board implemented in accordance with a third preferred embodiment of the present invention;

FIG. 10 is a perspective exploded view of the message board of FIG. 9;

FIG. 11 is front view of an assembled message board implemented in accordance with a third preferred embodiment of the present invention;

FIG. 12 is a perspective exploded view of the message board of FIG. 11;

FIG. 13 is a perspective exploded view of a assembled message board implemented in accordance with a fourth preferred embodiment of the present invention;

FIG. 14 is front view of an assembled message board implemented in accordance with a fifth preferred embodiment of the present invention;

FIG. 15 is a perspective exploded view of the message board of FIG. 14;

FIG. 16 is front view of an assembled message board implemented in accordance with a sixth preferred embodiment of the present invention;

FIG. 17 is a perspective exploded view of the message board of FIG. 16;

FIG. 18 is flowchart of a method for making a message board of the invention;

FIG. 19 is flowchart of a method of advertising through use of the message board of the invention; and

FIG. 20 is front view of an assembled message board for use in a retail environment;

FIG. 21 is a view of a lower message surface of the message board of FIG. 20 showing a sample message arrangement;

FIG. 22 is a plan view of an upper surface of the message board of FIG. 20 showing a sample windows arrangement;

FIG. 23 is a perspective view of a retail scenario where message boards implemented in accordance with FIGS. 20-22 are utilized to convey messages and advertising to retail consumers;

FIG. 24 is a perspective view of a dorm scenario wherein a message board implemented in accordance with the principles of the invention is utilized to convey messages and advertising to door room visitors;

FIG. 25 is front view of an assembled message board illustrating use of shape and styling of the surfaces of the board to promote awareness of a company or product;

FIG. 26 is a perspective exploded view of the message board of FIG. 25; and

FIG. 27 is rear view of the assembled message board of FIG. 25.

### DETAILED DESCRIPTION OF THE PREFERRED EMBODIMENTS

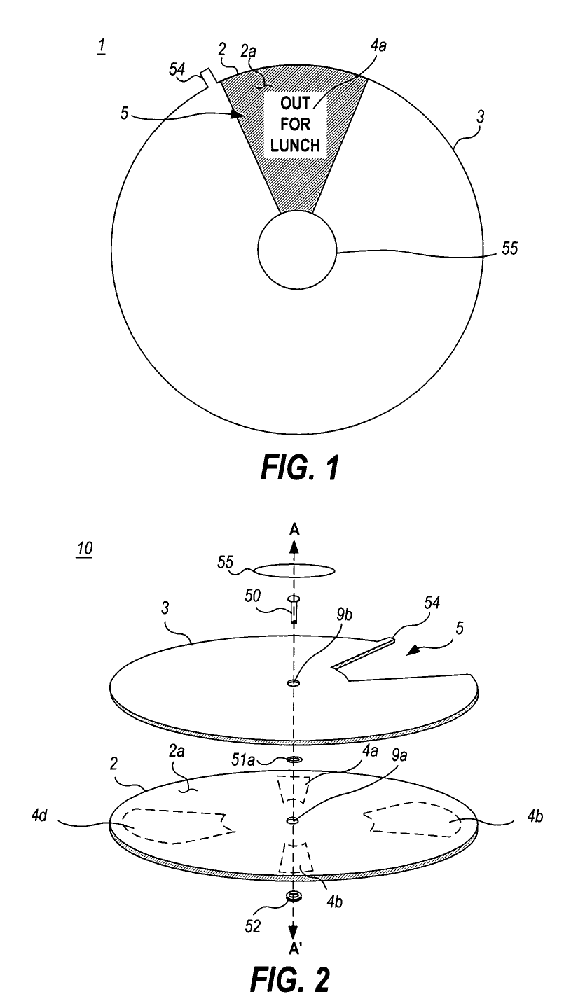

FIG. 1 illustrates an assembled message board 1 implemented in accordance with a preferred embodiment of the invention and FIG. 2 illustrates an exploded view of the message board 1 of FIG. 1.

In this simplest embodiment, the message board 1 comprises two surfaces 2 and 3. The two surfaces 2 and 3 are rotatable around a single axis, indicated as dashed line A-A′. The first surface 2 includes a plurality of messages 4a, 4b, 4c, 4d distributed on a front face 2a of the surface 2 and arranged in a predetermined pattern.

The second surface 3 is stacked over the front face 2a of the first surface 2 and rotatably connected at axis A-A′. The second surface 3 comprises one or more windows 5. Each window 5 is designed in terms of position and size with the capability of respectively displaying at most one of the messages 4a, 4b, 4c, or 4d distributed on a front face 2a of surface 2 at any given position of rotation of the surface 3 with respect to surface 2.

Surfaces 2 and 3 are preferably made of thin rigid or semi-rigid material such as plastic or cardboard. In one embodiment, the first surface 2 may be made of opaque, semi-transparent, or transparent material while the second surface 3 may be opaque. In this embodiment, as surface 3 is rotated relative to the first surface 2, one of the messages 4a, 4b, 4c, or 4d on surface 2 is revealed through the window 5 while the remaining messages remain hidden under the surface 3. Means for attaching the message board to surfaces are provided such that it does not hinder the relative rotation of the surfaces 2 and 3 with respect to each other. These means such as sticky tape, hooks, Velcro, glue, screws, magnets, etc., can be attached to the back side of surfaces 2 or 3 depending on which of the surfaces will be allowed to freely rotate.

In an alternative embodiment, the first surface 2 may be made of opaque, semi-transparent, or transparent material while the second surface 3 is semi-transparent. In this embodiment, as surface 3 is rotated relative to the first surface 2, one of the messages 4a, 4b, 4c, or 4d on surface 2 is revealed through the window 5 while the remaining messages remain semi-hidden under surface 3.

In yet an alternative embodiment, the first surface 2 may be made of opaque, semi-transparent, or transparent material while the second surface 3 is transparent or semi-transparent of a first color, and window 5 is transparent of a second color. In this embodiment, as surface 3 is rotated relative to surface 2, one of the messages 4a, 4b, 4c, or 4d on surface 2 is revealed and highlighted by the second color through the window 5 while the remaining messages are visible through surface 3 but un-highlighted by the first color.

The relative rotation between the two surfaces 2 and 3 can be achieved by rotation of either surface 2 or 3. In one mode of operation, the first surface 2 is attached to a fixed surface (for example, a wall, a board, a door, etc.) and surface 3 is rotated relative to surface 2. In another mode of operation, the axis A-A′ of rotation of the two surfaces 2, 3 is supported while either of the two surfaces 2, 3 is free to rotate with respect to the other. The rotation of the surfaces 2, 3 could be achieved manually or through an electro-mechanical device.

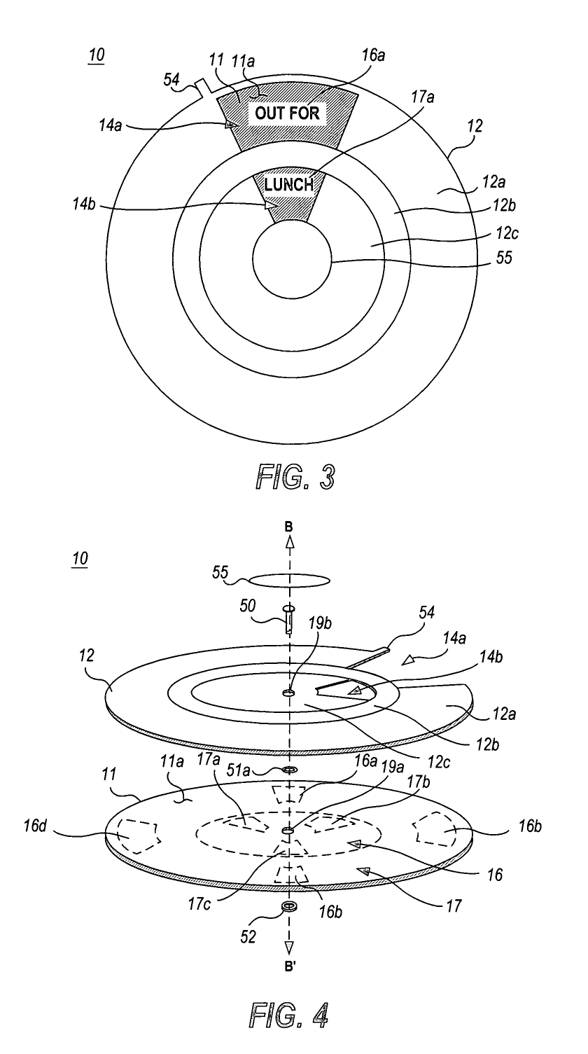

FIG. 3 illustrates an assembled message board 10 implemented in accordance with a preferred embodiment of the invention and FIG. 4 illustrates an exploded view of the message board 1 of FIG. 3.

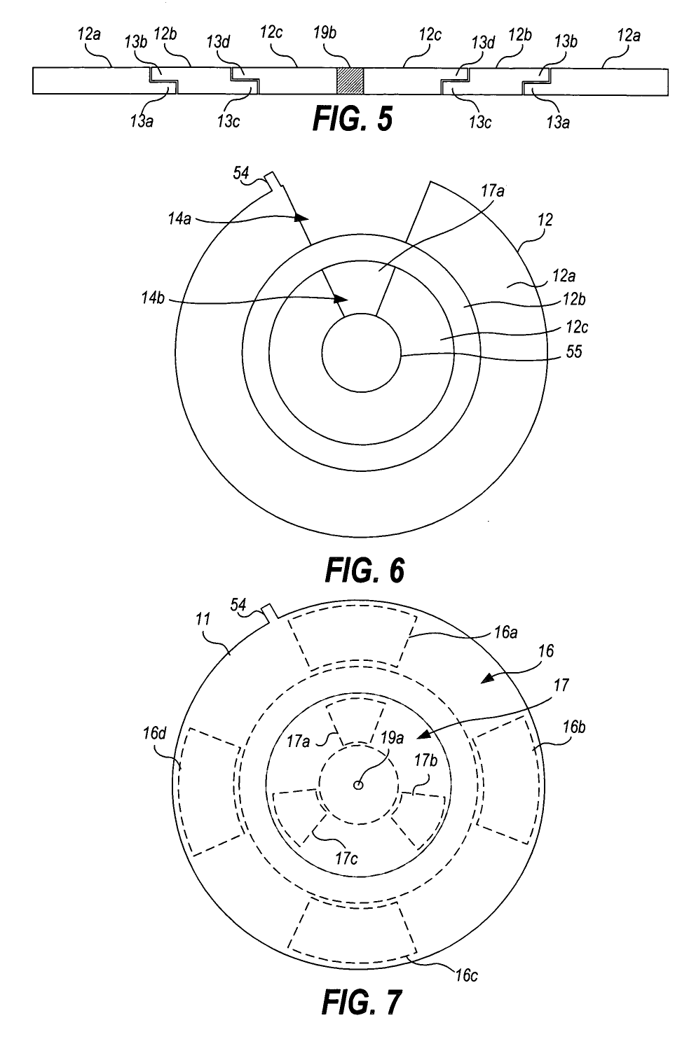

In this embodiment, the message board 10 comprises two surfaces 11 and 12. The two surfaces 11 and 12 are rotatable around a single axis, indicated as dashed line B-B′. In this embodiment the overlaying surface 12 includes a plurality of concentric interfacing rings 12a, 12b, 12c connected such that they are rotatable with respect to each other. In the preferred embodiment, the interfacing rings 12a, 12b, 12c are connected together using a lap joint arrangement at the interfaces of the rings 12a, 12b, 12c. FIG. 5 is a cross-sectional side view illustrating this arrangement. As shown therein, the outer ring 12a is configured with a lap member 13a formed along its inner edge. The middle ring 12b is configured with a lap member 13b formed along its outer edge. When assembled, lap member 13b overlaps lap member 13a such that ring 12b rotatably secures ring 12a around ring 12b. Middle ring 12b is also configured with a lap member 13c formed along its inner edge. The inner ring 12c is configured with a lap member 13d formed along its outer edge. When assembled, lap member 13c overlaps lap member 13d such that ring 12c rotatably secures ring 12b around ring 12a. Additional rings may be similarly implemented.

One or more windows 14a, 14b may be formed in one or more of the concentric interfacing rings 12a, 12b, 12c. In the illustrative embodiment, shown in FIG. 6, a window 14a is formed in ring 12a and a window 14b is implemented in ring 12c.

Different subsets 16, 17 of messages may be distributed over surface 11 to be displayed through the different windows 14a, 14b implemented in rings 12a, 12c. FIG. 7 is a plan view of the first surface 11 implemented for use with second surface 12 in the embodiment shown in FIGS. 3-6. As illustrated in FIG. 7, messages 16a, 16b, 16c, 16d forming a first subset 16 of messages are distributed around the outer periphery of the surface 11 in a first concentric pattern as shown. Messages 17a, 17b, 17c forming a second subset 17 of messages are distributed around the center 11a of the surface 11 in a second concentric pattern as shown.

When the message board 10 is assembled, as shown in FIGS. 3 and 4, surface 12 (comprising rings 12a, 12b, 12c) is placed over the front face 11a of surface 11 in such a manner that ring 12a overlays the first subset 16 of messages arranged in the first concentric pattern and ring 12c overlays the second subset 17 of messages arranged in the second concentric pattern. Ring 12a may be rotated to allow window 14a to reveal one of the messages 16a, 16b, 16c, 16d in the first subset 16 of messages. Ring 12c may be independently rotated to allow window 14b to reveal one of the messages 17a, 17b, 17c in the second subset 17 of messages.

The use of independently rotatable rings 12a, 12b, 12c in surface 12 allows the windows implemented in each of the rings to be rotated while allowing other windows in different rings to remain fixed. This independent rotation adds further flexibility in the choice of the messages to display.

For example, ring 12c may be rotated to change the message displayed through window 14b while allowing ring 12a to remain stationary such that the message displayed through window 14a remains unchanged. Thus, the message displayed through one window 14a can have one of several qualifiers displayed through the second window 14b. These qualifiers are selected by the relative rotation of the interior ring 12c with respect to messages on surface 11 while the exterior ring 12a is kept fixed.

The relative rotation between the two surfaces 11 and 12 can be achieved by rotation of either surface (or any combination of the rings 12a, 12b, 12c). In one mode of operation, surface 11 is attached to a fixed surface and the second surface 12 (or independent rings 12a, 12b, 12c) is rotated. This is a more suitable mode when the message board is to be attached to another surface (e.g., an office or residence door). In another mode of operation, the axis B-B′ of rotation of the two surfaces 11, 12 is supported while either of the two surfaces 11, 12 (or any combination of the rings 12a, 12b, 12c) is free to rotate with respect to the other. The rotation of the surfaces 11, 12 (or any combination of the rings 12a, 12b, 12c) may be achieved manually or through an electro-mechanical device.

It will be appreciated that the number and placement of rings and the number and placement of the windows in the various rings may vary according to the particular application. For example, ring 12b may be implemented to include its own set of windows to reveal one or more of its own associated subset of messages. Moreover, there may be additional rings which may or may not include windows to reveal associated messages.

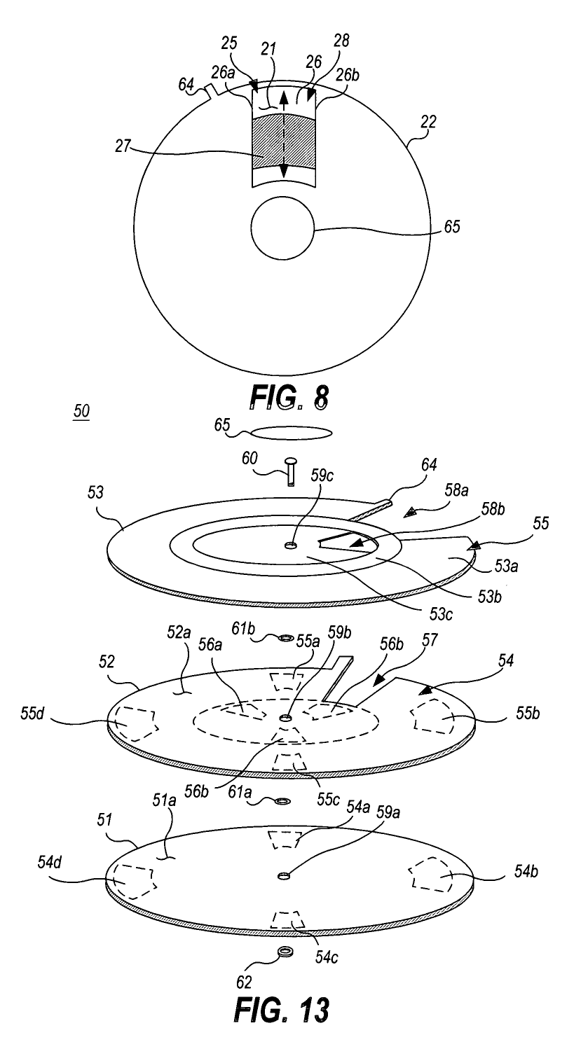

Radial relative repositioning of the windows on a surface 22 relative to a lower level surface 21 on the stack of surfaces may also be achieved through window design. FIG. 8 illustrates an alternative embodiment of a window 25 that allows radial repositioning without rotation of the surfaces 11, 12. In this embodiment, the window 25 comprises an opening 26 with sides 26a, 26b parallel to a given radius of the surface 22. A cover 27 partially fills the opening 26, creating a see-through portion 28 of the opening 26. The cover 27 slides within the opening 26 such that it can be repositioned to different radial positions. This effectively repositions the see-through portion 28 of the window 25 to a new radial position as well. This radial movement adds further flexibility in the selection of messages to reveal through the windows.

The radial repositioning of windows such as window 25 in FIG. 8 allows different sets of messages to be distributed over the lower surface(s) 21 at different radii. A subset of one message set is revealed through the opening 26 on the lower surface 21, as surface 22 containing the window 25 is rotated, with the cover 27 set at one radial position. The see-through portion 28 of the opening 26 can then be repositioned radially such that a subset of a different message set is selected and displayed through the see-through portion 28 of the opening 26 in its new position, as surface 22 is rotated.

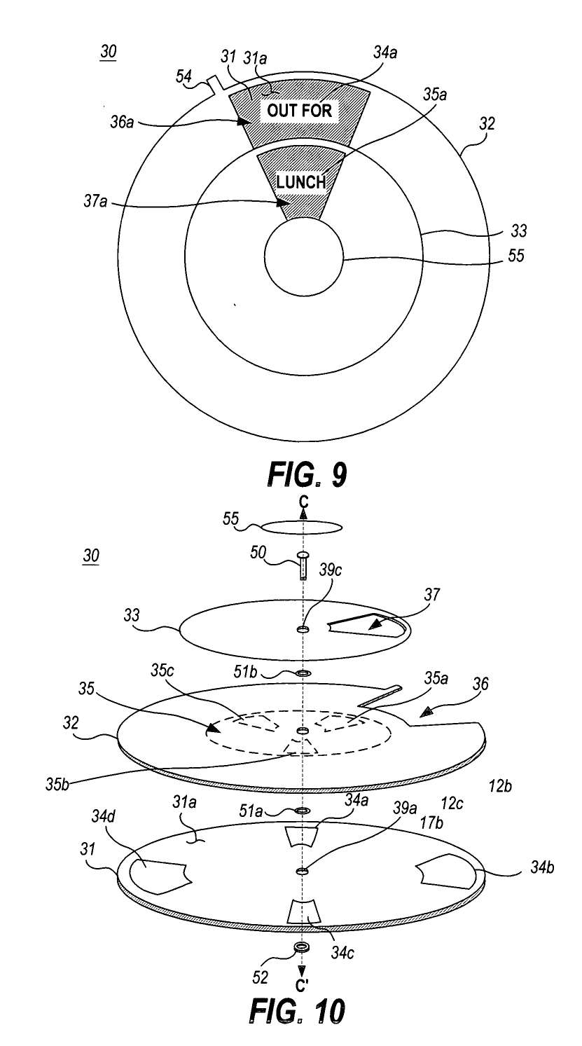

FIG. 9 illustrates an assembled message board 30 implemented in accordance with another preferred embodiment of the invention and FIG. 10 illustrates an exploded view of the message board 30 of FIG. 9. Message board 30 comprises three or more surfaces 31, 32, and 33. In this embodiment, each of the surfaces 31, 32, and 33 are rotatable around a single axis, indicated as dashed line C-C′. Surface 1 includes a first set 34 of messages 34a, 34b, 34c, 34d that are distributed on a front face 31a of surface 31 in a first predefined pattern. Surface 32 includes a second set 35 of messages 35a, 35b, 35c distributed on a front face 32a of surface 32 in a second predefined pattern. Surface 32 also includes one or more windows 36a. Surface 33 includes one or more windows 37a.

Surface 33 is stacked on top of surface 32, and surface 32 is stacked on top of surface 31. Each of surfaces 31, 32, and 33 rotate independently of one another. In the illustrative embodiment, surfaces 31, 32, and 33 are connected to be rotatable around the same axis of rotation C-C′.

In operation, as surface 33 is rotated relative to surface 32, a subset of messages 35a, 35b, 35c from the set 35 of available messages distributed over surface 32 is revealed through the windows 37a of surface 33. Similarly, as surface 32 is rotated relative to surface 31, a subset of messages 34a, 34b, 34c, 34d from the set 34 of available messages distributed over surface 31 is revealed through the windows 36a of surface 32. It should be noted that additional surfaces may be further similarly added to the stack of surfaces 31, 32, 33. Each additional surface may include viewing windows that allow messages belonging to sets of messages on surfaces below it in the stack to be revealed via appropriate rotation of the additional surface.

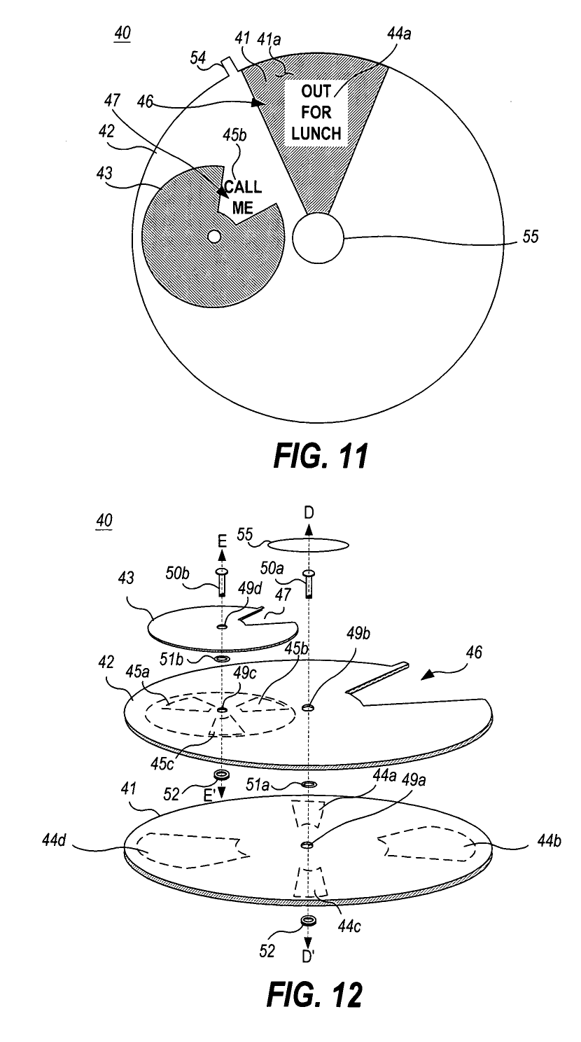

In another alternative embodiment, illustrated in FIGS. 11 and 12, multiple surfaces 41, 42, 43 may be connected to rotate around multiple axes. As illustrated therein, surface 42 rotates relative to surface 41 around axis D-D′, while surface 43 rotates relative to surface 42 around axis E-E′.

FIG. 13 illustrates another alternative embodiment of a message board 50 implemented in accordance with the principles of the invention. As shown therein, message board 50 includes surfaces 51 and 53. Surface 53 comprises concentric interfacing rings 53a, 53b, 53c. Additional surfaces may be stacked between surface 51 and surface 53, as illustrated in FIG. 13 by single surface 52. These additional surface(s) 52 are used to increase the number of messages that can be displayed by the message board. The additional surface(s) 52 includes one or more windows that may be aligned with windows on front-most surface 53 such that a subset of messages on one or more surfaces below it in the stack can still be viewed through the aligned windows. Moreover, a number of messages may be distributed over surface(s) 52. For example, surface 51 includes a set 54 of messages 54a, 54b, 54c, 54d arranged in a predefined pattern around its outer edge. Surface 52 includes a set 55 of messages 55a, 55b, 55c, 55d arranged in a predefined pattern around its outer edge and a set 56 of messages 56a, 56b, 56c, 56d arranged in a predefined pattern around its inner edge. Surface 52 also includes a window 57 that, when the message board 50 is assembled, aligns with at most one of the messages 54a, 54b, 54c, 54d on the front face 51a of surface 51. Surface 53 includes a window 58a implemented in ring 53a and a window 58b implemented in ring 53c. When the message board 50 is assembled, window 58b aligns with either at most one of the messages 56a, 56b, 56c, 56d on the front face 52a of surface 52. Window 58a aligns with either at most one of the messages 55a, 55b, 55c, 55d on the front face 52a of surface 52 or with the window 57 of surface 52 to reveal at most one of the messages 54a, 54b, 54c, 54d on the front face 51a of surface 51.

Operation of the message board 50 requires proper alignment and simultaneous rotation of surface 53 and surface 52. If it is desirable to display the messages on any given surface 51, 52, 53, of the message board, the windows on those surfaces stacked in front of the given surface in the stack must be aligned through appropriate rotation of those surfaces. The surfaces stacked in front of the given surface displaying the desired message may then be simultaneously rotated relative to the given surface, resulting in subsets of messages on the given surface to be revealed through windows of each of the surfaces stacked in front of the given surface. For example, with the message board 50 of FIG. 13, aligning windows 57 and 58a of surfaces 52 and 53 exposes a portion of the front face 51a of surface 51. Surfaces 52 and 53 may then be simultaneously rotated with respect to surface 51 to select one of the messages 54a, 54b, 54c, or 54d on surface 51. Alternatively, ring 53a of surface 53 may be rotated relative to surface 52 to select one of the messages 55a, 55b, 55c, 55d on surface 52. In either case, ring 53c of surface 53 may be rotated relative to surface 52 to select one of the messages 56a, 56b, 56c, 56d on surface 52.

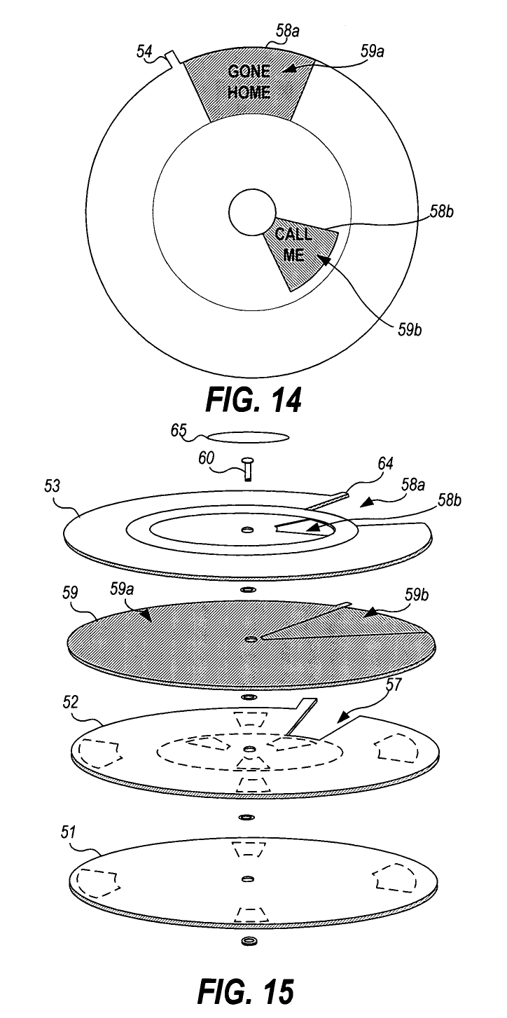

In an alternative embodiment shown in FIGS. 14 and 15, one or more transparent surfaces 59 comprising transparent material of a first color 59a and a second color 59b may be added to the stack of surfaces to allow the user to highlight a message displayed through one or more windows 58a, 59a with different colors. For example, in FIG. 14, the message displayed in window 58b is overlaid with the second color 59b of transparent surface 59, while the message displayed in window 58a is overlaid with the first color 59a of transparent surface 59. The availability of multiple transparent colors allows the ability to highlight certain messages using color.

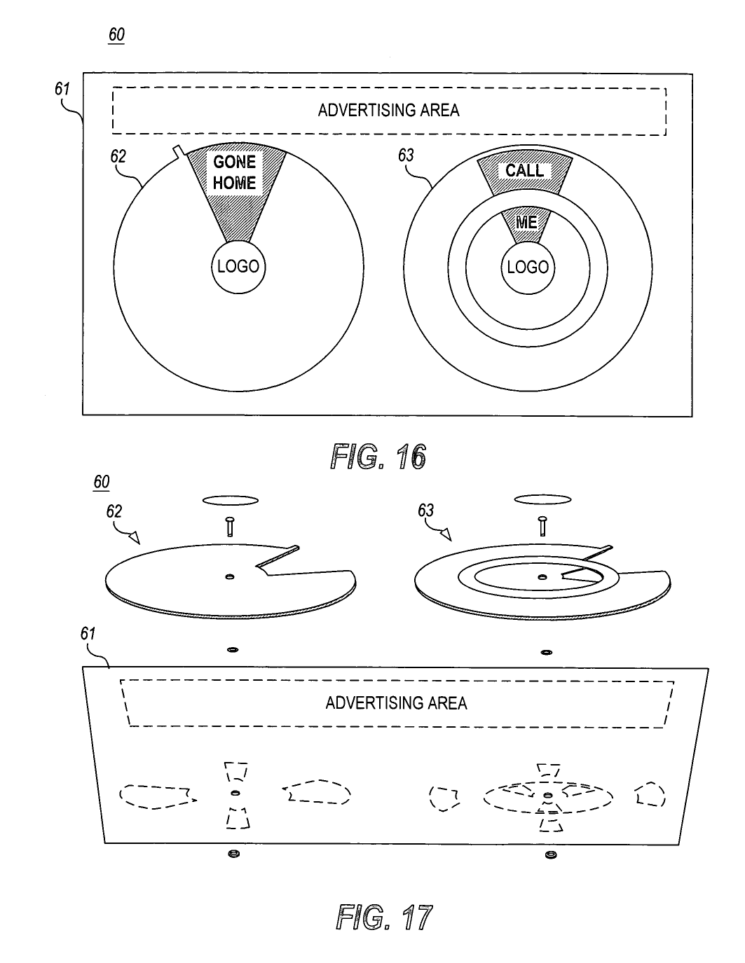

Multiple instances or combinations of the embodiments previously presented may be combined to form a larger message board having multiple axes of rotation. One example of this embodiment is shown in FIGS. 16 and 17, wherein the message board 60 includes a surface 61 which serves as the back-most surface of a message board 62 implemented according to the embodiment of FIGS. 1 and 2, and a second message board 63 implemented according to the embodiment of FIGS. 3 and 4.

Rotational connection of the various surfaces comprising the message board in any of the previously described embodiments may be achieved using various well-known mechanisms, including but not limited to round-head two-prong brass fasteners, screw posts, snaps, pins with backs, etc. In the illustrative embodiments, the surfaces of the message board are connected together using a threaded bolt 60 inserted through a concentric hole 9a, 9b, 19a, 19b, of proportional size in each of the surfaces. Washers 61a, 61b of appropriate thicknesses may optionally be layered between each of the surfaces to provide a small amount of separation between the surfaces. A threaded nut 62 screws onto the threaded portion of the shaft to rotatably secure the surfaces concentrically around the axis of the bolt. It will be understood that the nut 62 will be screwed on to a point to provide appropriate level of contact among the surfaces. The appropriate level of contact among the surfaces is such that it ensures that the surfaces can rotate easily when external torque is applied, but that the surfaces will remain in position when no external torque is present.

In each of the embodiments described herein, the message board may include handles 54 attached (formed integral or non-integral) to one or more of the surfaces comprising the message board to allow for easy rotation of the surfaces.

Also in each of the embodiments described herein, the messages may comprise text, graphics, or other images. The messages may be printed directly on the surfaces. Alternatively sheets made of appropriate materials such as paper or plastic with an adhesive on their backside and printed or fill-in messages on their front side may be provided. The messages may then be affixed to the predefined message locations on the front faces of the appropriate surfaces by the user. This allows the user to design a customized set of message choices.

Also in each of the embodiments described herein, any of the persistently exposed areas of the surfaces (i.e., those areas of the surfaces that are displayed regardless of the rotation of the various surfaces) may be used to provide an advertising area, a customized name or logo, a picture, or any other image to be displayed regardless of the selected message.

Also in each of the embodiments described herein, an optional surface 65 may be connected on any of the exposed areas of the surfaces, which may be used to provide an advertising area, a customized name or logo, a picture, or any other image to be displayed regardless of the selected message. The size of this surface is determined such that it does not obscure the viewing of messages through the windows of the surfaces comprising the message board.

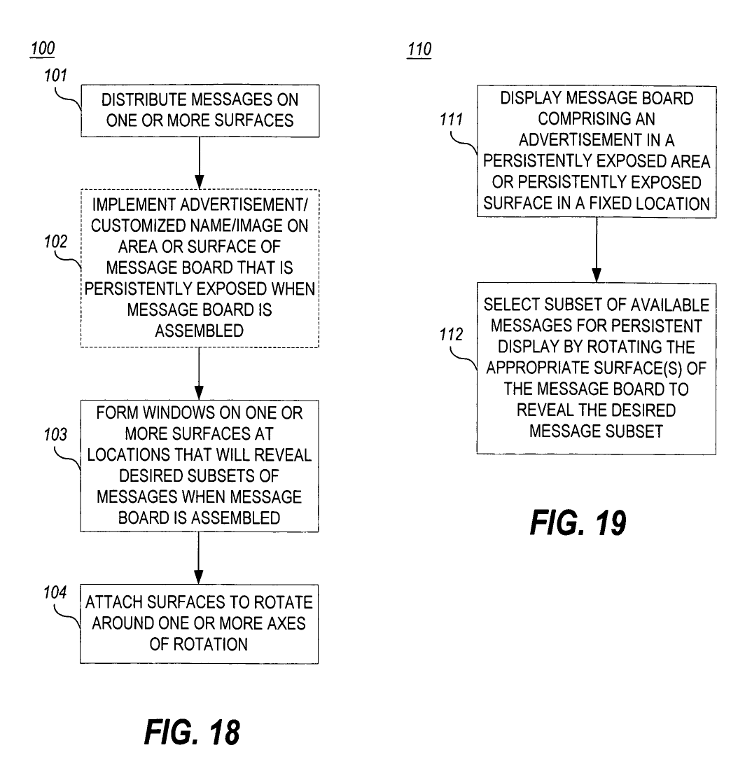

FIG. 18 is a method 100 for making a message board of the invention. As illustrated therein, a set of available messages is distributed across a subset of surfaces (step 101). Optionally, as indicated by dashed lines, an advertisement, customized name and/or image may be implemented (step 102) on an area of a surface that will be persistently exposed when the message board is assembled. Windows are formed (step 103) on one or more surfaces at locations that will reveal desired subsets of messages when the message board is assembled. The surfaces are attached to rotate around one or more axes of rotation (step 104).

It is to be understood that the purpose of a message board is to persistently display a message to be conveyed to its intended recipient(s) of the message. Accordingly, it is contemplated that the message board is to be located in an area where the intended recipient(s) know to look or are likely to see it. The message board of the invention may configured for personal use or for use in commercial establishments. In addition, when used as an advertising medium, it is contemplated that the nature of the messages are such as to provide an incentive for the end user to utilize the message board for communicating with the end user's intended message recipients by placing the message board in a fixed prominent location, thus persistently displaying the advertisement.

As just described, the message board may be used commercially as a means for advertising. FIG. 19 illustrates a method of advertising through use of the message board of the invention. In this method 110, a message board in accordance with the invention and comprising an advertisement in a persistently exposed area or persistently exposed surface of the message board is displayed in a prominent fixed location (step 111). A subset of available messages is selected for persistent display (step 112), for example by rotating the appropriate surface(s) of the message board to reveal the desired subset of messages. The persistently displayed message draws viewers to observe the advertisement during the course of receiving the persistently displayed message. The advertisement may include a company name, a logo, a trademark, a tradename, a service mark, text, and/or graphical or photographical images.

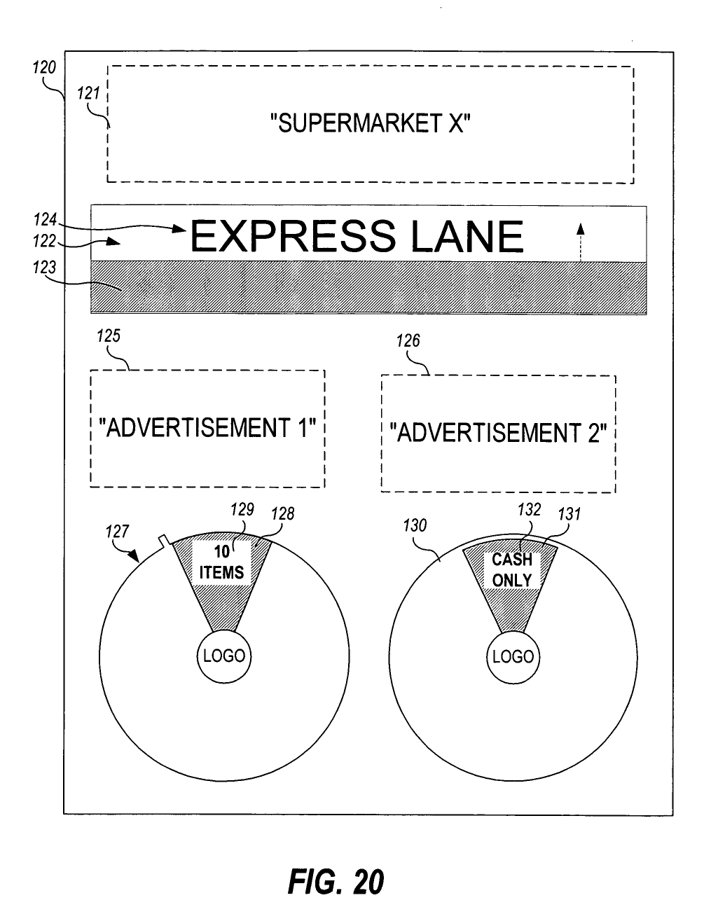

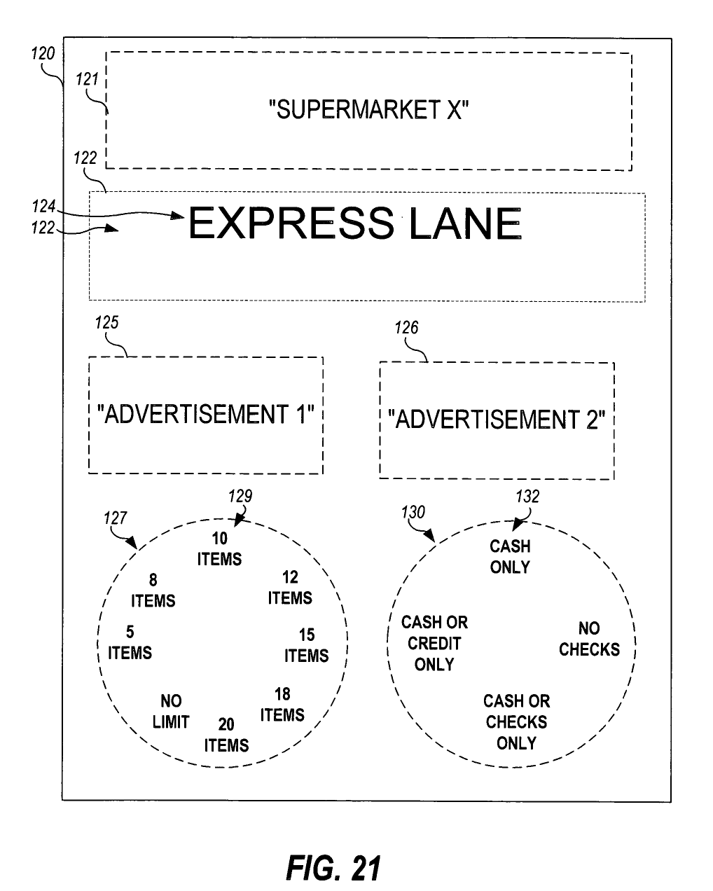

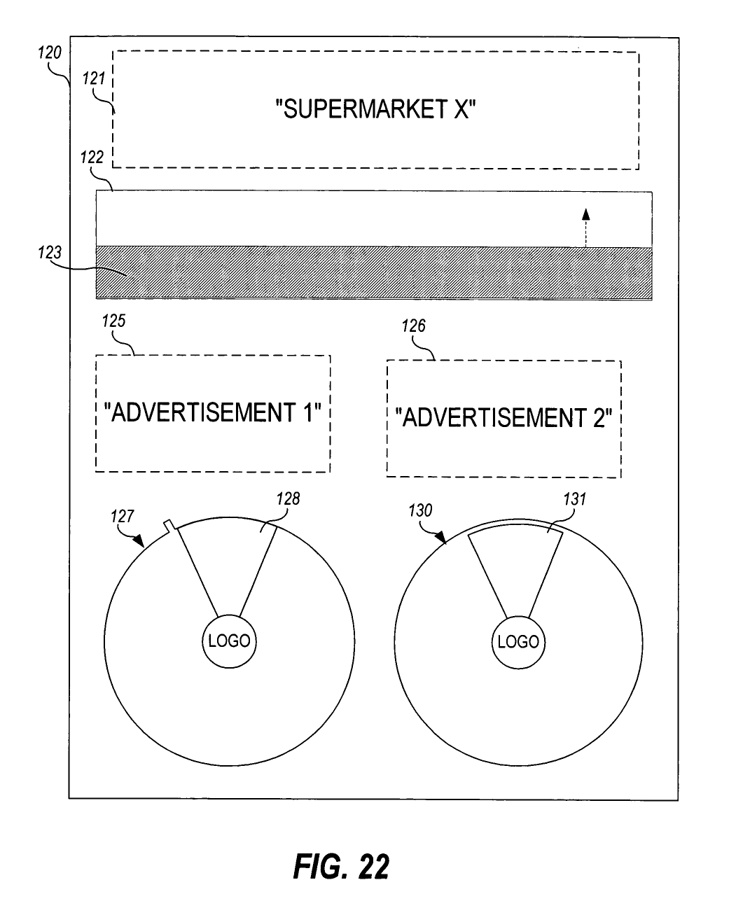

For example, FIGS. 20-22 illustrate a message board 120 for use in a supermarket. The message board is for use at a checkout lane and includes messages for indicating whether the lane is an express lane or regular lane, the number of items allowed, and the form of payment allowed for that lane.

In particular, the message board 120 includes a window 122 having a slidable cover 123 implemented in accordance with the embodiment described in FIG. 8. This slidable cover 123 slides up or down as indicated by the arrow, and selectively reveals or does not reveal a message “EXPRESS LANE” 124 through see-through portion of the window 122.

Message board 120 also includes an “item limit” message board 127 implemented in accordance with the embodiment of FIGS. 1 and 2, having a window 128 that reveals a selected message 128 indicating the item limit for the lane. Message board 120 also includes a “payment methods accepted” message board 130 implemented in accordance with the embodiment of FIGS. 1 and 2, having a window 131 that reveals a selected message 131 indicating the types of payment accepted in this lane.

Message board 120 also includes advertising areas 121, 125, 126 that are persistently displayed and which customers are drawn to view due to the draw of the message board in displaying information about the checkout land that is desired by the customers.

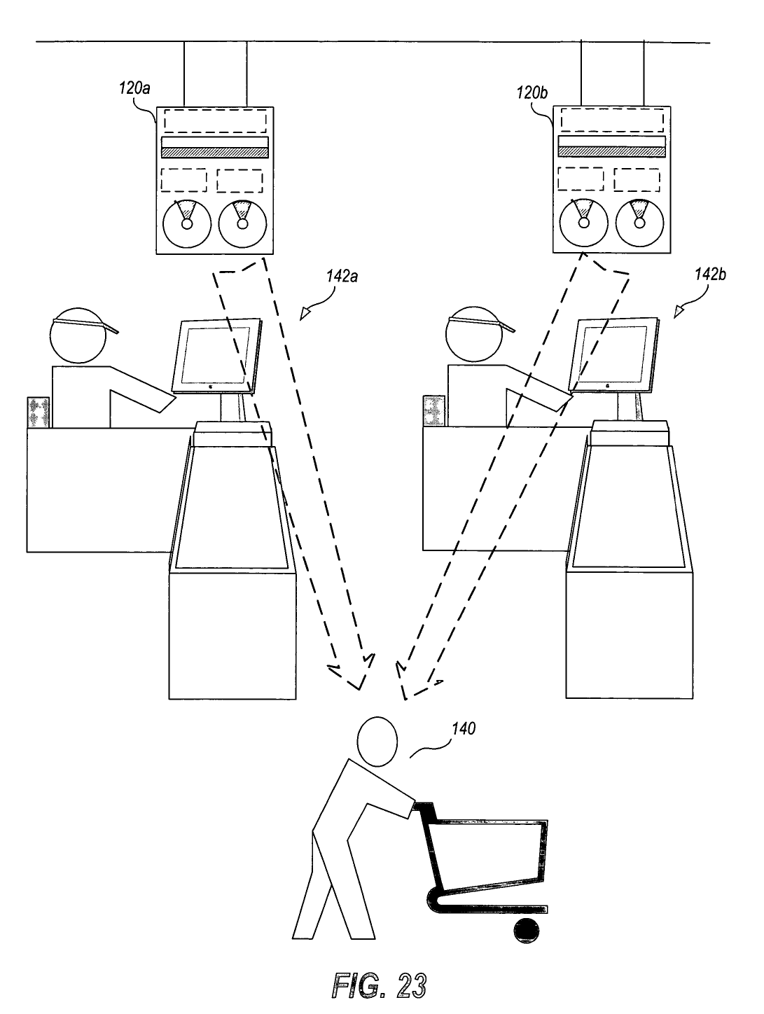

FIG. 23 illustrates a retail scenario where message boards 120a, 120b implemented in accordance with FIGS. 20-22 are utilized to convey messages and advertising to retail consumers 140. A message board 120a, 120b is displayed above or in front of each checkout lane 142a, 142b. Because the message boards 120a, 120b are persistently displayed in a prominent location and contains persistent information that retail consumers 140 desire or need to know about the checkout lanes 142a, 142b that they are considering entering, the message boards 120a, 120b draw the attention of its intended recipients, and in the course of reading or observing the persistently displayed messages, they are also drawn to notice the persistently displayed advertisements on the permanently exposed advertising areas or surfaces of the message boards 120a, 120b.

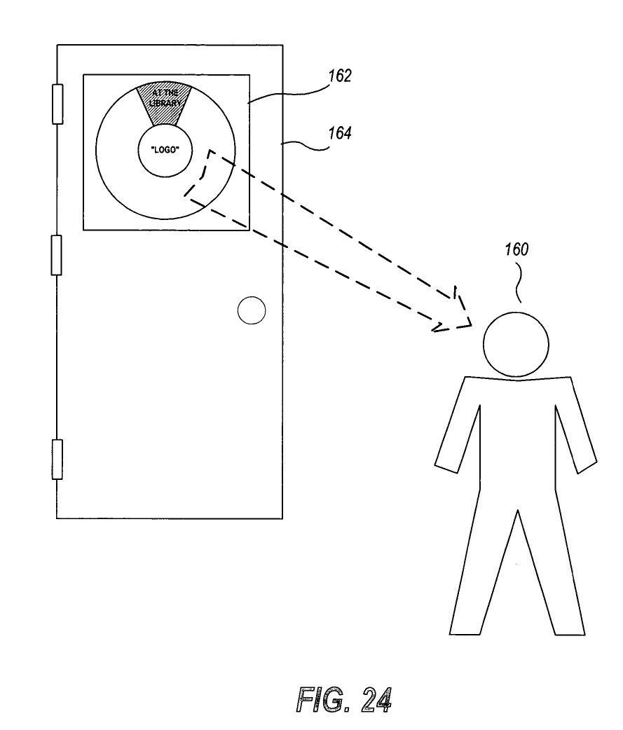

In a similar way, message boards used in a non-commercial environment, for example on a dorm room door, also convey both messages and advertisements. For example, as shown in FIG. 24, a message board 162 implemented in accordance with the principles of the invention described herein is hung on a dorm room door 164. The message board 162 conveys information about the location of the occupant of the room that is desired by visitors 160 to the dorm room door. In the course of reading or observing the persistently displayed messages from the board 162, the visitors 160 are also drawn to notice the persistently displayed advertisements on the permanently exposed advertising areas or surfaces of the message boards 162.

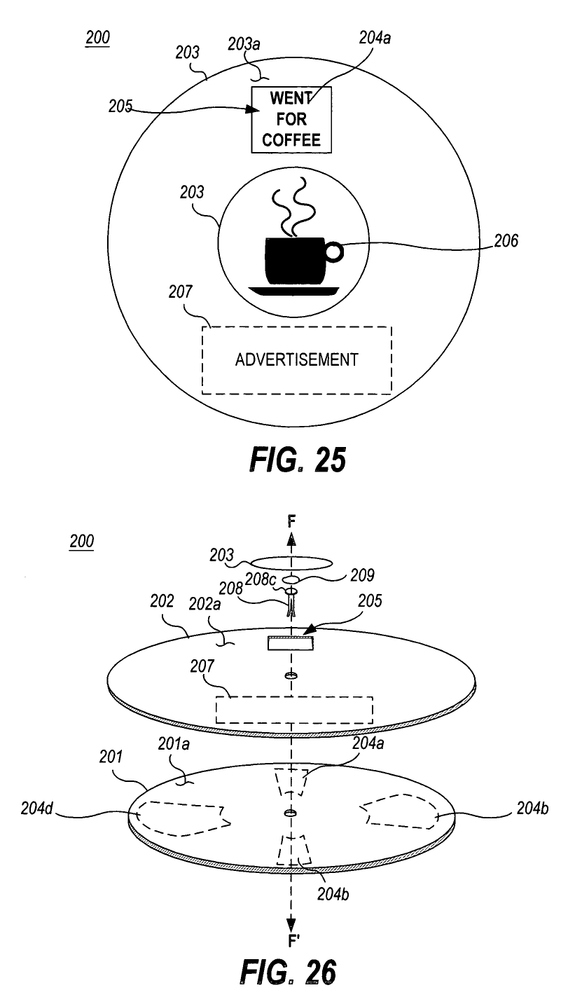

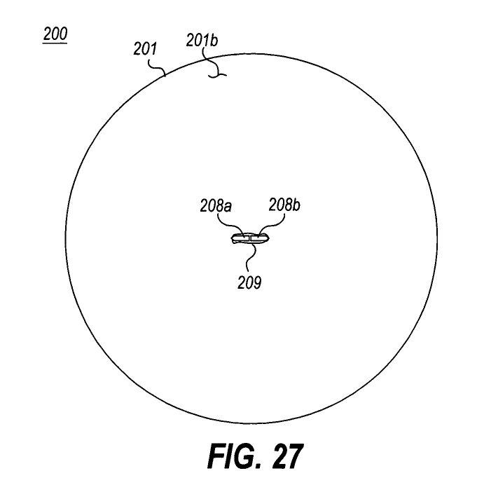

The shape and styling of the message board may be configured in virtually an unlimited number of different forms, and may be designed for personal tastes or to promote commercial advantage. For example, in order to cause the viewer to think of a particular company, one of the surfaces may be shaped and styled as the image of a trademark or company logo. In another example, one of the visible surfaces may be shaped and styled as a particular object that may cause the consumer to think of something that a company sells. FIGS. 25, 26, and 27 illustrate an example of a message board 200 that promotes awareness of a company through the shape and styling of the surfaces of the board. As illustrated therein, the message board 200 includes a surface 202 in the shape of a donut with a window 205 formed therein. Surface 202 overlays a lower surface 201 on which messages 204a, 204b, 204c, 204d are printed. Surface 201 and surface 202 are attached via a two-prong brass pin 208. In the preferred embodiment, the pin 208 is inserted front-to-back through the surface 202 and then through surface 201, and the prongs 208a, 208b of the two-prong brass pin are flayed and glued 209 to the back face 201b of surface 201, as illustrated in FIG. 26. A surface 203 that may have an advertisement or novelty image 206 printed or adhered thereon is glued 209 or otherwise attached to the head 208c of the two-prong brass pin 208. Because surface 203 is fixedly and non-rotatably attached to surface 201 due to glue 209, messages 204a, 204b, 204c, 204d may therefore be selected by rotating the surface 203. Rotation of surface 203 therefore causes the surface 201 to rotate. In the alternative, a novelty item or other object may be adhered to the head 208c of the two-prong brass pin 208 in place of surface 203 and used to rotate the surface 201 to select the desired message 204a, 204b, 204c, 204d for display through window 205 on surface 202.

The shape and style of the message board 200 may be used to promote commercial products or services. In the illustrative embodiment, surface 202 is configured in the shape of a donut and preferably includes graphical imagery that further enhances the “donut” imagery. Further in this example, the rotational device is surface 203, which contains a novelty image, e.g., a cup of coffee, which further enhances the donut and coffee imagery. Messages may be selected by rotating the coffee cup (or the surface on which the coffee cup is printed/adhered). The advertiser may therefore be a coffee or donut manufacturer or vendor such that the donut and coffee imagery reminds the viewer of the coffee or donut vendor/manufacturer (i.e., the source of the donuts or coffee). The advertisement may therefore contain the trademark or logo of the vendor/manufacturer of specific coffee or donuts.

It should be understood that the current invention is not limited to the embodiments described above, but encompasses any and all embodiments within the scope of the following claims.

What is claimed is:

1. A message board for persistently displaying a selected set of messages, said message board comprising:
a plurality of surfaces rotatably connected around one or more axes;
a plurality of messages distributed on one or more of said surfaces;
one or more windows formed in one or more of said surfaces for selectively revealing one or more subsets of said plurality of messages for persistent display, wherein said selected one or more subsets of said plurality of messages may be changed to persistently display a different one or more subsets of said plurality of messages.

2. The message board of claim 1, comprising:
attachment means for mounting said message board in a location for persistent display.

3. The message board of claim 1, wherein:
one of said plurality of surfaces comprises a customized persistently displayed image on an exposed area for all positions of rotation of said plurality of surfaces.

4. The message board of claim 3, wherein:
said customized persistently displayed image comprises an advertisement.

5. The message board of claim 1, wherein:
at least one of said one or more windows comprises a movable cover repositionable in a radial direction.

6. The message board of claim 1, wherein:
one or more of said plurality of surfaces comprise independently rotatably connected concentric interfacing rings.

7. The message board of claim 6, wherein:
one or more of said one or more windows is formed in one or more of said rings.

8. The message board of claim 2, wherein:
one of said plurality of surfaces comprises a customized persistently displayed image on an exposed area for all positions of rotation of said plurality of surfaces.

9. The message board of claim 8, wherein:
said customized persistently displayed image comprises an advertisement.

10. The message board of claim 2, wherein:
at least one of said one or more windows comprises a movable cover repositionable in a radial direction.

11. The message board of claim 2, wherein:
one or more of said plurality of surfaces comprise independently rotatably connected concentric interfacing rings.

12. The message board of claim 2, wherein:
one or more of said one or more windows is formed in one or more of said rings.

13. A method for making a message board, said method comprising the steps of:
distributing a set of available messages across a first subset of a plurality of surfaces;
forming windows in a second subset of said plurality of surfaces at locations that will reveal one or more of a plurality of subsets of said available messages for persistent display when said message board is assembled;
rotatably attaching said plurality of surfaces around one or more axes of rotation.

14. The method of claim 13, further comprising:
implementing an advertisement, customized name and/or image on an area of one or more of said plurality of surfaces that will be persistently exposed when said message board is assembled.

15. A method for advertising, said method comprising the steps of:
displaying a message board in a prominent fixed location, said message board comprising a plurality of surfaces rotatably connected around one or more axes, a plurality of messages distributed on one or more of said surfaces, one or more windows formed in one or more of said surfaces for selectively revealing one or more subsets of said plurality of messages for persistent display, wherein said selected one or more subsets of said plurality of messages may be changed to persistently display a different one or more subsets of said plurality of messages, and an advertisement and/or corporate name and/or corporate logo persistently displayed on an exposed area of said message board for all positions of rotation of said plurality of surfaces; and
selecting a subset of said plurality of messages for persistent display.

16. The method of claim 15, wherein said step of selecting said subset of said plurality of messages for persistent display comprising the step of:
rotating a subset of said plurality of surfaces of said message board to persistently display said selected subset of said plurality of messages.

17. A message board for persistently displaying a selected set of messages, said message board comprising:
a first surface comprising a plurality of messages to be made available for persistent display;
a second surface rotatably attached over said first surface, said second surface comprising one or more windows configured to persistently display a subset of said plurality of messages on said first surface;
a rotational device attached to said first surface such that rotation of said rotational device rotates said first surface to allow selection of said subset of said plurality of messages for persistent display through said one or more windows of said second surface; and
an advertisement and/or corporate name and/or corporate logo on a persistently exposed viewing area of any surface of said message board, said an advertisement and/or corporate name and/or corporate logo conveying a source of goods or services.

18. The message board of claim 17, wherein:
said message board comprises a shape and/or style that reminds a viewer of a source of said source of goods or services.

19. The message board of claim 17, wherein:
said rotational device comprises a third surface attached to said first surface, wherein said third surface comprises an advertisement and/or corporate name and/or corporate logo.
